(19) United States
(12) Patent Application Publication
(10) Pub. No.: US 2015/0227596 A1
(43) Pub. Date: Aug. 13, 2015

(54) SYSTEMS AND METHODS FOR HIERARCHICAL ENTERPRISE DATA MANAGEMENT

(71) Applicant: The Procter & Gamble Company, Cincinnati, OH (US)

(72) Inventor: Pawel Bober, Warsaw (PL)

(21) Appl. No.: 14/592,021

(22) Filed: Jan. 8, 2015

Related U.S. Application Data
(60) Provisional application No. 61/938,754, filed on Feb. 12, 2014.

(51) Int. Cl. G06F 17/30

(52) U.S. Cl. CPC G06F 17/30557; G06F 17/30589

(57) ABSTRACT

Included are embodiments for hierarchical enterprise data management. Some embodiments include receiving a plurality of enterprise entities for an enterprise, creating a hierarchical structure for the plurality of enterprise entities, and receiving crowd sourced data for a selected enterprise entity of the plurality of enterprise entities. Similarly, some embodiments include associating an application with the selected enterprise entity, receiving a user selection of the application and the selected enterprise entity, and running the application with the crowd sourced data for the selected enterprise entity. Still some embodiments are configured to provide results of the application for display.

### FIELD OF THE INVENTION

The present application relates generally to systems and methods for hierarchical enterprise data management and specifically to providing a computing infrastructure to organize enterprise information assets into a hierarchical structure and utilize that hierarchical structure to crowd source enterprise data modeling and provide analytics on that data.

### BACKGROUND OF THE INVENTION

Many companies wish to run reports and other analytics on various aspects of a business, but have difficulty doing so because the desired data is often difficult to access. As an example, a large company may have dozens of divisions, each running with their own data retention and storage policies. As such, someone wishing to determine a metric with regard to one or more of those corporate divisions may not have access to the appropriate data either because some or all of the data is not stored or because the data is not properly integrated for the request. In addition to the difficulty in accessing the data to perform the desired task, current enterprise modeling practices require effort intensive, modeling activities that have to be undertaken by the highly-skilled resources. Those activities are performed with the use of sophisticated application or programs.

### SUMMARY OF THE INVENTION

Included are embodiments of a method for hierarchical enterprise data management. Some embodiments include receiving a plurality of enterprise entities for an enterprise, creating a hierarchical structure for the plurality of enterprise entities, and receiving crowd sourced data for a selected enterprise entity of the plurality of enterprise entities. Similarly, some embodiments include associating an application with the selected enterprise entity, receiving a user selection of the application and the selected enterprise entity, and running the application with the crowd sourced data for the selected enterprise entity. Still some embodiments are configured to provide results of the application for display.

Also included are embodiments of a computing device. Some embodiments of the computing device include a memory component that stores logic that causes the system to determine a plurality of enterprise entities for an enterprise, create a hierarchical structure for the plurality of enterprise entities, and receive crowd sourced data for a selected enterprise entity of the plurality of enterprise entities. In some embodiments, the logic causes the system to provide a user interface for associating an application with the selected enterprise entity, receive a user selection of the application and the selected enterprise entity, and run the application with the crowd sourced data for the selected enterprise entity. In some embodiments, the logic causes the system to provide results of the application for display.

Also included are embodiments of a non-transitory computer-readable medium. Some embodiments of the non-transitory computer-readable medium include logic that causes a computing device to determine a plurality of enterprise entities for an enterprise, create a hierarchical structure for the plurality of enterprise entities, and receive crowd sourced data for a selected enterprise entity of the plurality of enterprise entities. In some embodiments, the logic causes the computing device to provide a first user interface for associating an application with the selected enterprise entity, receive a selection of the application and the selected enterprise entity, and run the application with the crowd sourced data for the selected enterprise entity. The logic may also cause the computing device to provide results of the application for display.

### BRIEF DESCRIPTION OF THE DRAWINGS

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate various embodiments described herein, and together with the description serve to explain the principles and operations of the claimed subject matter.

FIG. 1 depicts a computing environment for hierarchical enterprise data management, according to embodiments disclosed herein;

FIG. 2 depicts a remote computing device that may be utilized for hierarchical enterprise data management, according to embodiments disclosed herein;

FIG. 3 depicts an example of top level enterprise information assets structure, according to embodiments disclosed herein;

FIG. 4 depicts a user interface for creating a hierarchy of enterprise entities representing enterprise information assets at various degrees of abstraction and granularity, according to embodiments disclosed herein;

FIG. 5 depicts a user interface for providing properties of an enterprise entity with respect to the enterprise systems which use the information assets represented by the enterprise entity, from a data perspective, according to embodiments disclosed herein;

FIG. 6 depicts a graphical representation of a hierarchy of enterprise entities that have been associated to model dimension hierarchies, according to embodiments disclosed herein;

FIG. 7 depicts a user interface of properties of an enterprise entity in relation to the Enterprise Data Dictionary form a data perspective, according to embodiments disclosed herein;

FIG. 8 depicts a user interface of properties of an enterprise entity in relation to the enterprise systems which use the information assets represented by the enterprise entity from an application/system perspective, according to embodiments disclosed herein;

FIG. 9 depicts a user interface that may be provided for creating and/or viewing an enterprise entity diagram, according to embodiments disclosed herein;

FIG. 10 depicts a user interface that may be provided for creating and/or viewing an enterprise entity diagram, according to embodiments disclosed herein;

FIG. 11 depicts a table associated with the use enterprise entities, according to embodiments disclosed herein;

FIG. 12 depicts a table for providing enterprise entity hierarchy and grain data for applications, according to embodiments disclosed herein;

FIG. 13 depicts a table for providing levels that are used in an enterprise entity type characteristics hierarchy along with the systems which use those levels, according to embodiments disclosed herein;

FIG. 14 depicts a table providing output data for an enterprise entity, according to embodiments disclosed herein;

FIG. 15 depicts a flowchart for providing hierarchical enterprise data management, according to embodiments disclosed herein

### DETAILED DESCRIPTION OF THE INVENTION

Embodiments disclosed herein include systems and methods for hierarchical enterprise data management. Accordingly, embodiments support data centric development by determining a hierarchical structure for an enterprise, where determining the hierarchical structure of an enterprise includes creating a plurality of enterprise entities that represent various information assets of the enterprise. Whereas an application centric development determines data after the applications and infrastructure are in place, embodiments disclosed herein may be configured to crowd source the data modeling across the enterprise, which may then be used to establish a development strategy resulting in a more optimal and rational landscape of systems/applications for an enterprise. Additionally, embodiments may be configured to receive crowd sourced data for the use of selected enterprise entity, a plurality of enterprise entities, and/or a sub-entity (or sub-entities). The crowd sourced data may be formatted according to a common or predetermined format, such that any permutation of data from the enterprise entities may be utilized together, depending on the particular tasks and/or applications. This data may be applied to a predetermined application for performing an analysis or other action on the data. One or more automated reports may be generated, based on the analysis. In such embodiments, a single enterprise entity may be utilized for a plurality of different applications.

Accordingly, embodiments disclosed herein significantly reduce the amount of time to perform conceptual data modeling from hours or days to minutes or seconds. Cross application analysis may now be performed with a push of a button. Additionally, a cross application view may also now be provided, which was previously unavailable without a dedicated effort.

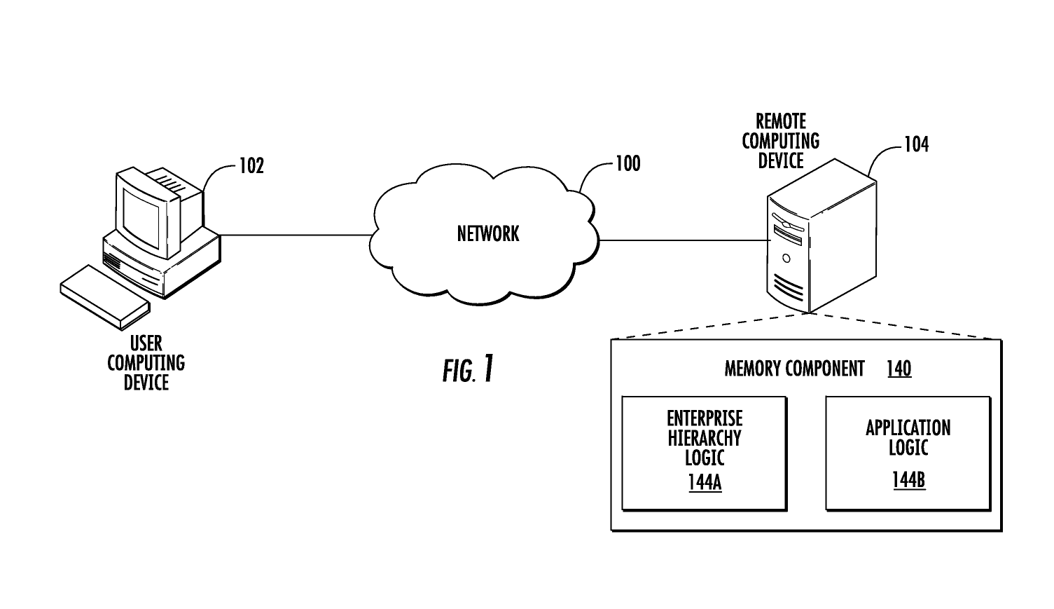

Referring now to the drawings, FIG. 1 depicts a computing environment for hierarchical enterprise data management, according to embodiments disclosed herein. As illustrated, a network 100 may be coupled to a user computing device 102 and a remote computing device 104. The network 100 may include any wide area and/or local area network, such as the internet, a mobile communications network, a satellite network, a public service telephone network (PSTN) and/or other network for facilitating communication between devices. If the network 100 includes a local area network, the local area network may be configured as a communication path via Wi-Fi, Bluetooth, RFID, and/or other wireless protocol.

The remote computing device 104 is also coupled to the network 100 and may be configured as an enterprise platform for storing the enterprise hierarchy logic 144a and/or the application logic 144b. Accordingly, the remote computing device 104 may include a personal computer, server, laptop computer, tablet, mobile communications device, database, and/or other computing device that is accessible by a user computing device 102 and/or other computing devices on the network 100.

It should also be understood that while the user computing device 102 and the remote computing device 104 are each depicted as individual devices, these are merely examples. Any of these devices may include one or more personal computers, servers, laptops, tablets, mobile computing devices, data storage devices, mobile phones, etc. that are configured for providing the functionality described herein. It should additionally be understood that other computing devices may also be included in the embodiment of FIG. 1.

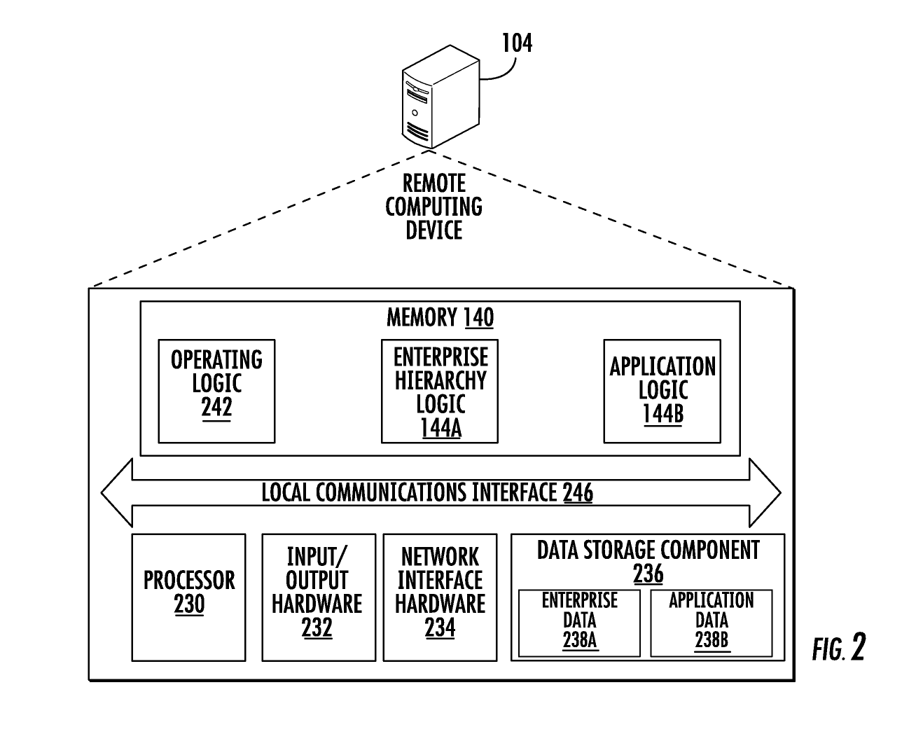

FIG. 2 depicts a remote computing device 104 that may be utilized for hierarchical enterprise data management, according to embodiments disclosed herein. In the illustrated embodiment, the remote computing device 104 includes a processor 230, input/output hardware 232, network interface hardware 234, a data storage component 236 (which stores enterprise data 238a and application data 238b), and the memory component 240. The memory component 240 includes hardware and may be configured as volatile and/or nonvolatile memory and, as such, may include random access memory (including SRAM, DRAM, and/or other types of RAM), flash memory, registers, compact discs (CD), digital versatile discs (DVD), and/or other types of non-transitory computer-readable mediums. Depending on the particular embodiment, a non-transitory computer-readable medium may reside within the remote computing device 104 and/or external to the remote computing device 104.

Additionally, the memory component 240 may be configured to store operating logic 242, the enterprise hierarchy logic 244a, and the application logic 244b, each of which may be embodied as a computer program, firmware, and/or hardware, as an example. A local communications interface 246 is also included in FIG. 2 and may be implemented as a bus or other interface to facilitate communication among the components of the remote computing device 104.

The processor 230 may include any hardware processing component operable to receive and execute instructions (such as from the data storage component 236 and/or memory component 240). The input/output hardware 232 may include and/or be configured to interface with a monitor, keyboard, mouse, printer, camera, microphone, speaker, and/or other device for receiving, sending, and/or presenting data. The network interface hardware 234 may include and/or be configured for communicating with any wired or wireless networking hardware, a satellite, an antenna, a modem, LAN port, wireless fidelity (Wi-Fi) card, WiMax card, mobile communications hardware, and/or other hardware for communicating with other networks and/or devices. From this connection, communication may be facilitated between the remote computing device 104 and other computing devices.

Similarly, it should be understood that the data storage component 236 may reside local to and/or remote from the remote computing device 104 and may be configured to store one or more pieces of data for access by the remote computing device 104 and/or other components. In some embodiments, the data storage component 236 may be located remotely from the remote computing device 104 and thus accessible via the network 100. In some embodiments however, the data storage component 136 may merely be a peripheral device, but external to the remote computing device 104.

Included in the memory component 240 are the operating logic 242, the enterprise hierarchy logic 244a, and the application logic 244b. The operating logic 242 may include an operating system and/or other software for managing components of the remote computing device 104. It should be understood that the components illustrated in FIG. 2 are merely exemplary and are not intended to limit the scope of this disclosure. While the components in

FIG. 2 are illustrated as residing within the remote computing device 104, this is merely an example. In some embodiments, one or more of the components may reside external to the remote computing device 104.

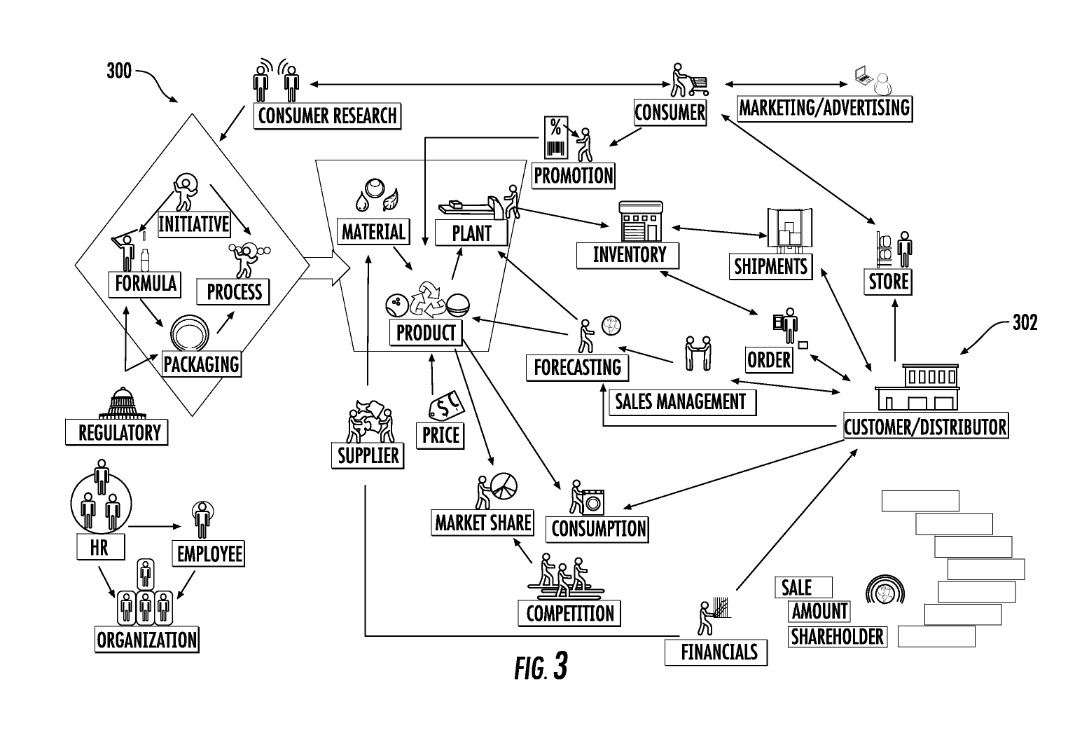

FIG. 3 depicts an example enterprise entity structure 300, according to embodiments disclosed herein. As illustrated in the enterprise entity structure 300, company's information assets may be represented by a plurality of different nodes, which may be a source of information. While some of these nodes may represent data from actual corporate divisions, not all of the nodes are so limited. As is evident, the complexity of the example enterprise entity structure 300 may make it difficult for many current solutions to perform data collection and modeling. Specifically, data may be collected in a different manner, in a different computing protocol and/or not at all. Accordingly, manually analyzing company data for these nodes would take weeks and necessitate the utilization of a professional, due to the complexity of the enterprise layout.

As illustrated in FIG. 3, a customer research node may interact with and/or communicate information regarding initiative, formula, process, and packing nodes, each of which may communicate with a regulatory node. The consumer research node may interact with a consumer node, which may also interact with a marketing/advertising node. The consumer node may also interact with a store node. The store node may receive data and inventory from a customer/distributor node 302, who may work with an ordering node, inventory node, shipment node, sales management node, forecasting node, etc. Similarly, the distributor node may interact with a finance node, a price node, a supplier node, a market share node, and a competition node. Additional nodes may include a human resources node, a reference data node, etc.

It should be understood that the layout provided in the example enterprise entity structure 300 may differ, based on the individual enterprise. Additionally, while each of the nodes on the example enterprise entity structure 300 is may represent a corporate division, one will understand that one or more of the nodes may not be actual corporate divisions, but merely sources of information. As an example, the order node may not be a corporate division, but when a customer makes an order, information may be collected and stored.

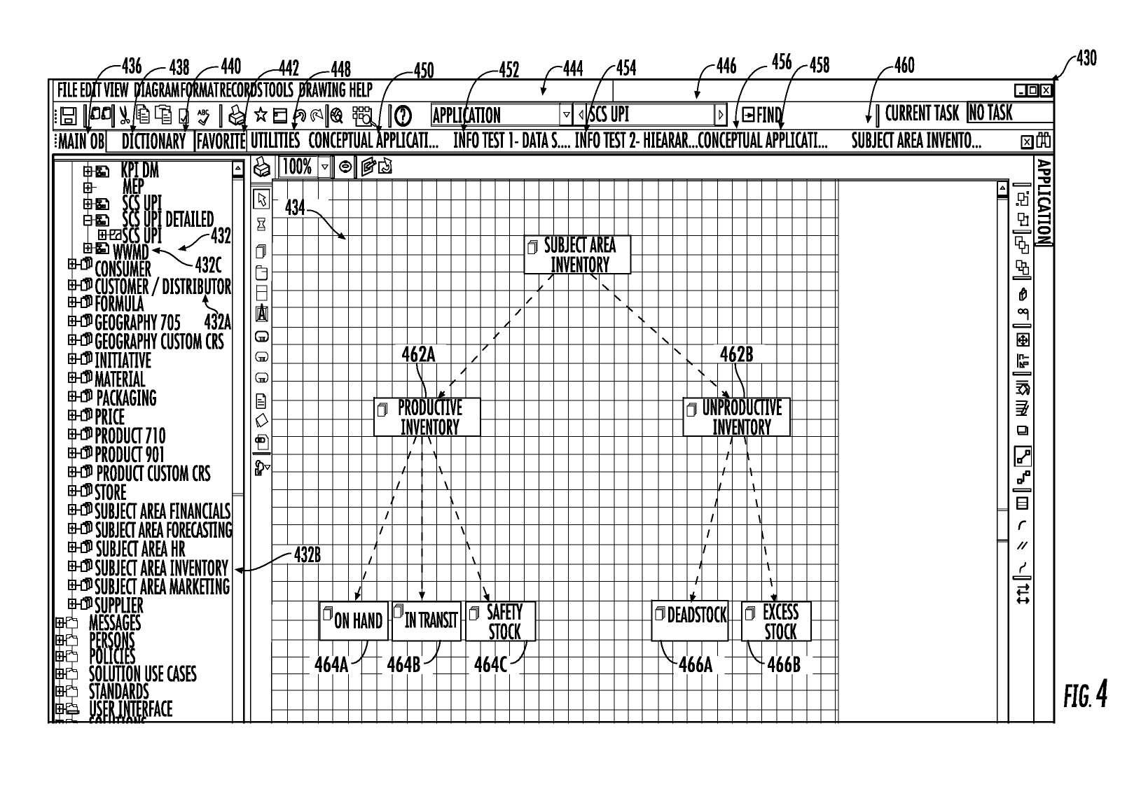

FIG. 4 depicts a user interface 430 for creating a hierarchy of enterprise entities, according to embodiments disclosed herein. As illustrated, the user interface 430 may include a plurality of options for compiling data from one or more nodes, structuring a project and/or executing an application to perform an analysis on various aspects of the enterprise. As an example, a user may construct a plurality of enterprise entities that represents the hierarchical structure of the enterprise nodes from FIG. 3. Once the hierarchy is constructed, the individual enterprise entities and applications may be represented in a hierarchy section 432 of the user interface 430. Additionally, with the hierarchy constructed, one or more nodes from FIG. 3 may be linked with a corresponding enterprise entity, such that information related to the node may be automatically compiled by the remote computing device 104. As an example, a customer/distributor enterprise entity 432a is provided in the hierarchy section 432. The customer/distributor enterprise entity 432a may additionally correspond with the customer/distributor node 302 from FIG. 3. Accordingly, the corporate information assets that correspond to the customer/distributor node 302 may be provided with a user interface, such as the user interface 430 from FIG. 4 that provides options for inputting and/or uploading conceptual data models from that division. In some embodiments, this communication of data models from the customer/distributor node 302 may be a manual exercise, automatic occurrence, based on periodic uploads, requests from the remote computing device 104, and/or via other triggering mechanism.

Because the nodes from FIG. 3 are linked to an enterprise entity, uniformity may be achieved with regard to data format, data upload frequency, etc. among each of the enterprise entities. Additionally, a user for an enterprise entity may be provided with additional options for altering the hierarchy provided in the hierarchy section 432 to accurately represent the corporate and/or data structure. Accordingly, the data for each enterprise entity may be updated via a crowd sourced environment to ensure the data and hierarchy are accurate.

The hierarchy section 432 also provides one or more applications, such as world wide market data (WWMD) application 432c that may be associated with one or more predetermined and/or selected entities. Accordingly, the user may “drag and drop” or otherwise place one or more of the applications into a workspace section 434 for configuring and/or executing.

Also provided in FIG. 4, the user interface 430 includes the workspace section 434, which allows a user to perform any of a plurality of different actions, such as viewing the entity hierarchy, creating a project, creating a new application, running an application, viewing reports, and/or other actions. As illustrated in FIG. 4, the user has selected a subject area inventory enterprise entity 432b. Accordingly, the hierarchy of this enterprise entity may be provided, which includes a productive inventory entity 462a and an unproductive inventory entity 462b. In the tier below these sub-entities are an on hand sub-entity 464a, an in transit sub-entity 464b, and a safety stock sub-entity 464c. Under the unproductive inventory directory are a deadstock sub-entity 466a and an excess stock sub-entity 466b.

Also included in the user interface 430 are a main tab 436, a projects tab 438, a diagram tab 440, and a favorites tab 442. While the main tab is depicted in FIG. 4, the projects tab 438 may be configured to provide a listing of other projects that the user has viewed and/or created. The diagram tab 440 may be configured to provide a listing of diagrams that the user has viewed and/or created. The favorites tab 442 may be configured to provide a listing of items that the user has identified as his/her favorites.

The user interface 430 also includes an action option 444, an action sub-option 446, a utilities option 448, a first conceptual application option 450, a first info test option 452, a second info test option 454, a second conceptual application option 456, a third conceptual application option 458, and a subject area inventory option 460. In response to selection of the action option 444 and the action sub-option 446, the user may signify the desired action to take. As an example, the user may execute an application, such as an application to view the information assets available in a system/application. As the enterprise may be vertically integrated, the net profit analysis may include the sales price and volume, versus the costs of distribution, production, marketing, and/or other criteria. As such, the application may access data from a plurality of different enterprise entities in order to identify applications in the enterprise with those information assets. By selecting the action option 444 and action sub-option 446 appropriately, the user may be able to perform this task.

Similarly, selection of the utilities option 448 provides utilities associated with setting up a hierarchy and/or running an application. Selection of one of the conceptual application options 450, 456, and/or 458 may initiate execution of the respective application. Selection of one of the info test options 452 and/or 454 may initiate execution of a predefined test. Execution of the subject area inventory option 460 provides data related to that application.

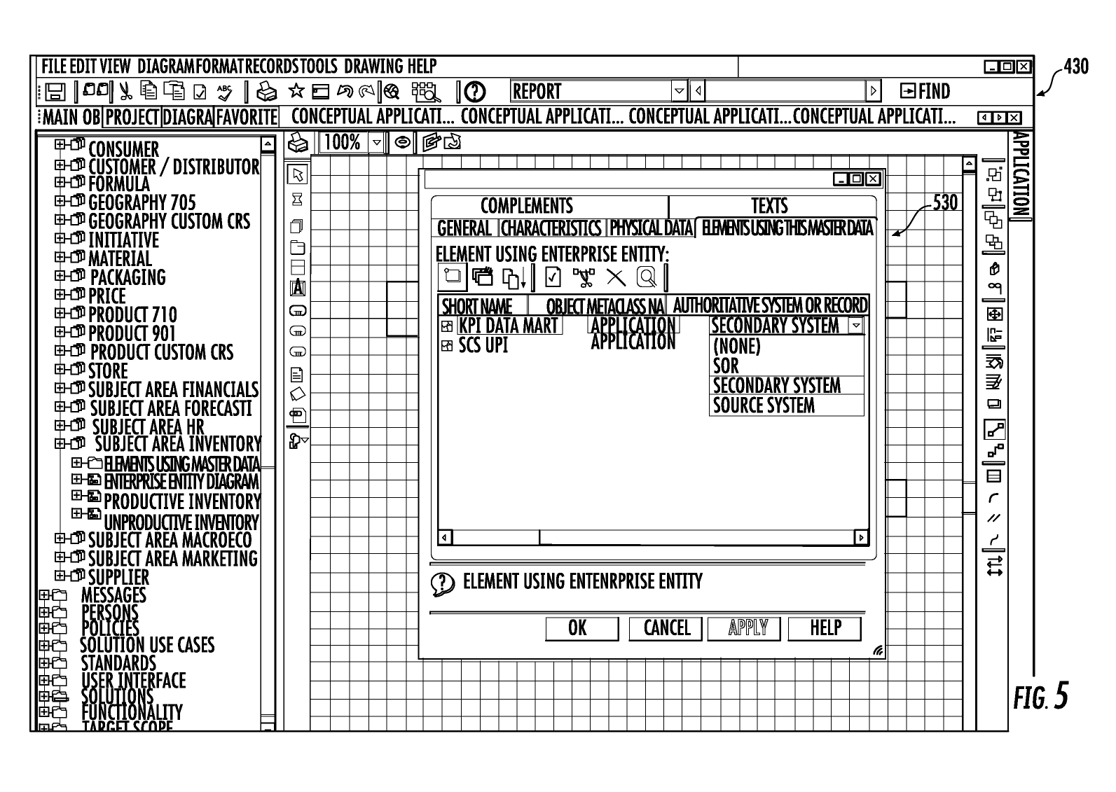

FIG. 5 depicts a user interface 530 for providing properties of an enterprise entity, according to embodiments disclosed herein. In response to selection of the productive inventory entity 462a from FIG. 4, the user interface 530 may be provided. The user interface 530 provides a short name for the entity, an object meta class name, and an authoritative system or record. Also provided are a complements tab, a texts tab, a general tab, a characteristics tab, and a physical data tab. In the user interface 530, the user may select the desired authoritative system or record for the selected entity. It should be understood that the embodiment of FIG. 5 may be utilized for viewing and associating the enterprise entity with an application. Accordingly, when an application is executed, the current state of the entity may be utilized. As such, the entity may be updated, as additional data is received and input into the remote computing device 104.

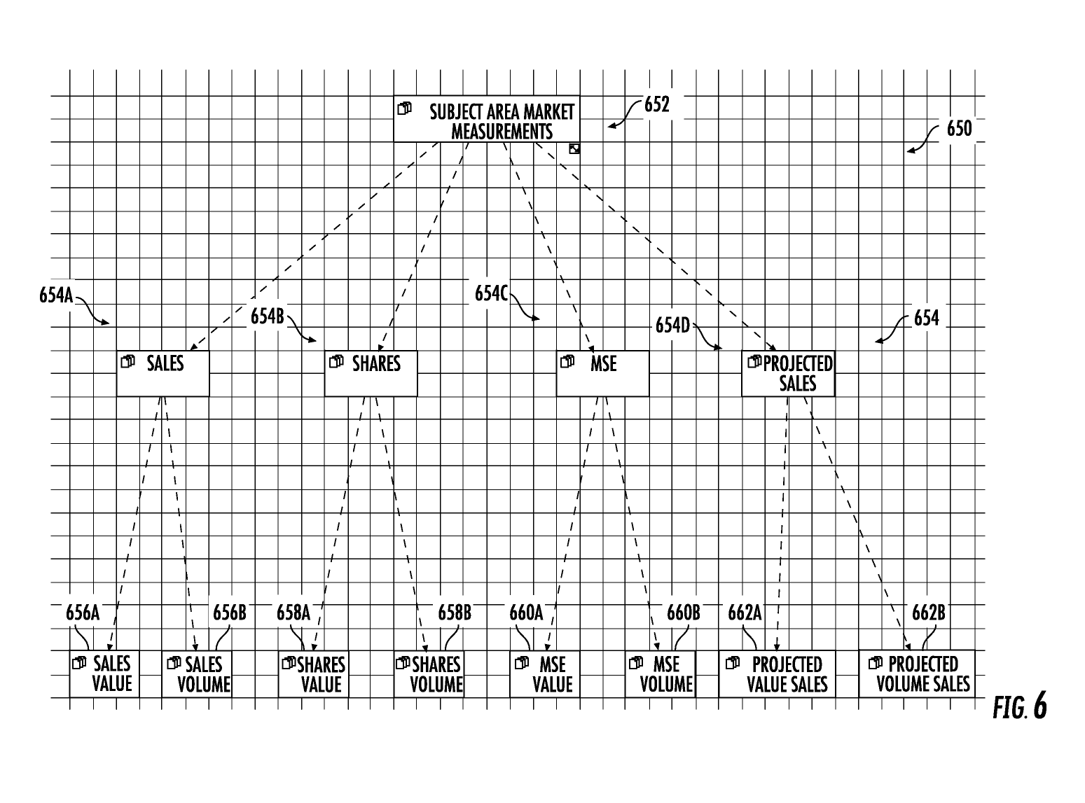

FIG. 6 depicts a graphical representation 650 of enterprise entities that have been associated to model dimension hierarchies, according to embodiments disclosed herein. Similar to the hierarchy from FIG. 4, FIG. 6 depicts a subject area market measurements entity 652. Lower in the hierarchy are a sales entity 654a, a shares entity 654b, a market sales estimate (MSE) entity 654c, and a projected sales entity 654d. Under the sales entity 654a are a sales value entity 656a and a sales volume entity 656b. Under the shares entity 654b are a shares value entity 658a and a shares volume entity 658b. Under the MSE entity 654c are a MSE value entity 660a and an MSE volume entity 660b. Under the projected sales entity 654d are a projected value sales entity 662a and a projected volume sales entity 662b.

It should be understood that a user may select one or more of the entities depicted in FIG. 6 and a properties user interface, such as the user interface 530 (FIG. 5) may be provided for viewing and/or altering the selected entity. Additionally, a user may define and/or alter the hierarchy structure to add and/or remove entities, based on the desired action to be taken.

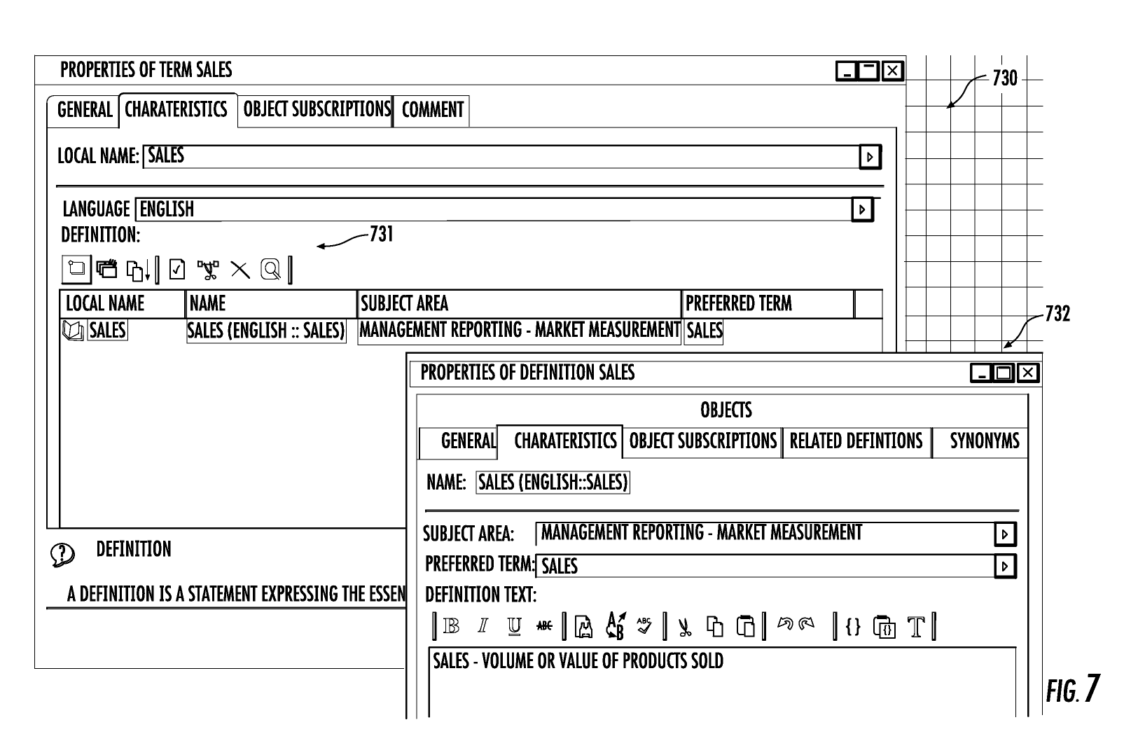

FIG. 7 depicts user interfaces 730, 732 depicting a properties window of an entity, according to embodiments disclosed herein. In response to selection of the sales entity 654a from FIG. 6, the user interface 730 may be provided. As illustrated, the user interface 730 may be configured to provide a plurality of options, such as general options, characteristics, object subscriptions, and commenting options. Under the characteristics option, where a user may view and/or edit the local name, the actual name, the subject area, and the preferred term. The user interface 730 also includes one or more definition options 731. In response to selection of one of the definition options 731, the user interface 732 may be provided. The user interface 732 may provide a general tab, a characteristics tab, an object subscriptions tab, a related definitions tab, and a synonyms tab. Also include are options for viewing and/or editing the preferred term, the subject area, and/or comments. Other options may also be provided.

FIG. 8 depicts a user interface 830 for providing master data and other properties regarding an enterprise entity with respect to an application, according to embodiments disclosed herein. In response to selecting the WWMD application 432c (FIG. 4), the user interface 830 may be provided. As illustrated, the user interface 830 includes a plurality of options for viewing, manipulating, creating, editing, and/or performing other actions for the selected application. Accordingly, the user interface 830 includes a service and request points option, a functionality option, a flows and roles option, a city planning option, cost option, a risks option, an instances option, a general characteristics option, and information technology (IT) health option, a responsibility option, a properties option, an architecture option, an object subscriptions option, a complements option, a texts options, a PG adoption (where) option, a technologies option, an objectives and requirements option, a collaboration option, an attribute policy option, a technology costs option, a usage option, a master data option, an adoption (how) option, a use case of subject option, and a standards option.

Also included in the user interface 830 are a local name field, an authoritative system or record field, an update frequency field, and an available history field. Based on the information provided in the fields and options, parameters of the application and its association with respective entities may be altered.

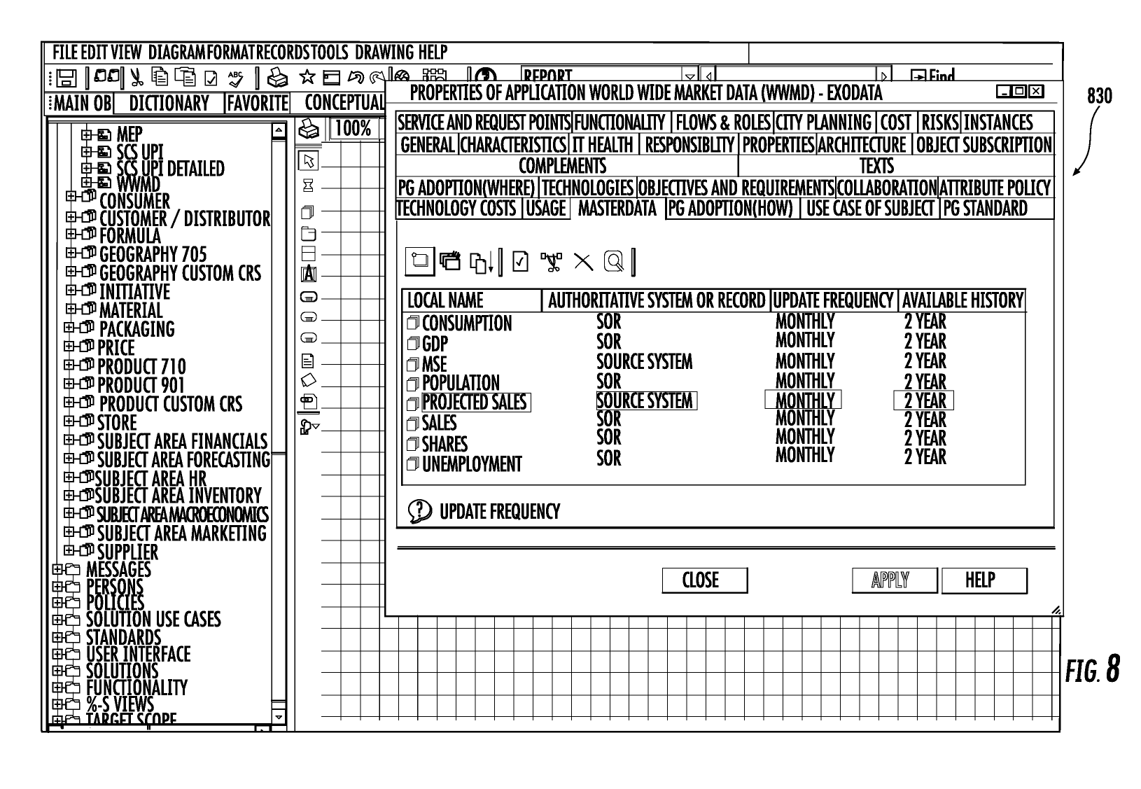

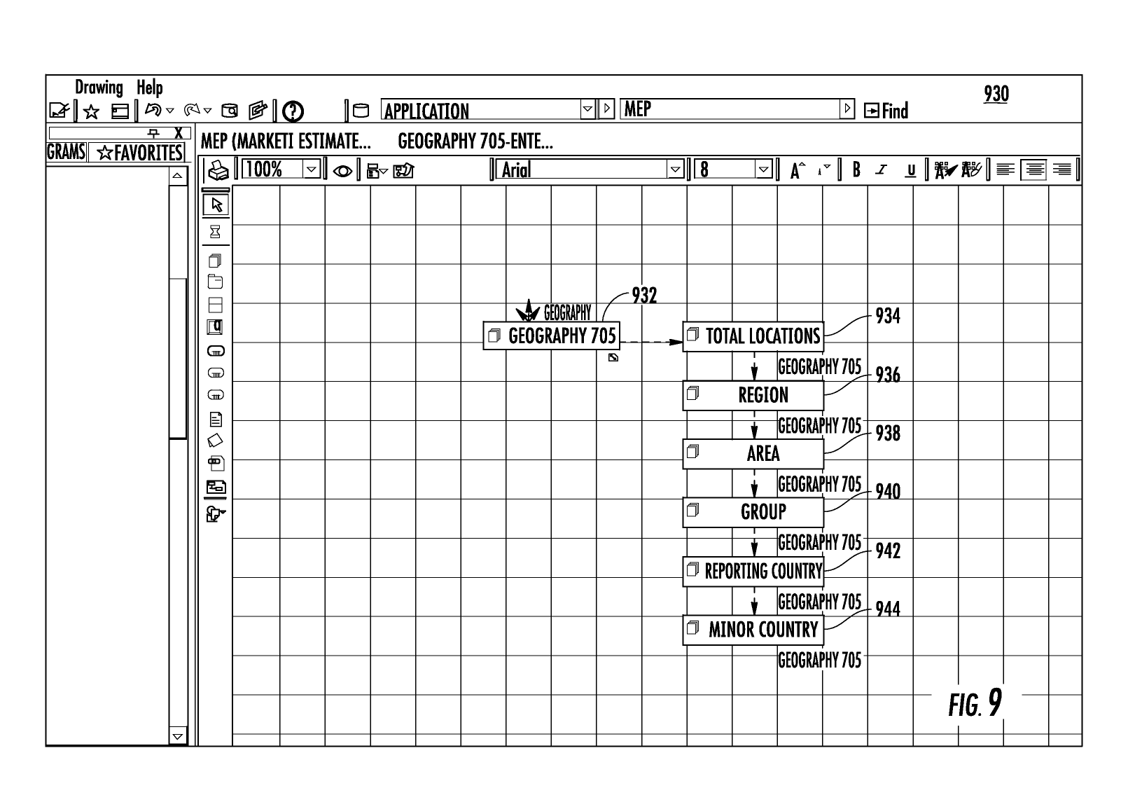

FIG. 9 depicts a user interface 930 that may be provided for creating and/or viewing an enterprise entity diagram, according to embodiments disclosed herein. As illustrated, the user interface 930 may include an enterprise entity characteristic 932. The entity enterprise may have been determined and/or selected, such and in the user interface 630 from FIG. 6. Regardless, the user can view, edit, and/or create the hierarchy type characteristics associated with the selected enterprise entity characteristic 932. As illustrated, the enterprise entity characteristic 932 may be associated with total locations 934, region 936, area 938, group 940, reporting country 942, and minor country 944.

FIG. 10 depicts a user interface 1030 that may be provided for creating and/or viewing an enterprise entity diagram, according to embodiments disclosed herein. As illustrated, the user interface 1030 may include an application that has been associated with an enterprise entity. Specifically, a market estimates and projection application 1032 is provided in the user interface 1030. Also provided are enterprise entities, such a macroeconomics 1038, sales 1040 and MEP 1042 and the association with the MEP application 1032. Also provided are enterprise entity type characteristics, such as segment 1034 and minor country 1036. Enterprise entity hierarchies (1044a-1044e) are also provided for the enterprise entities and enterprise entity type characteristics.

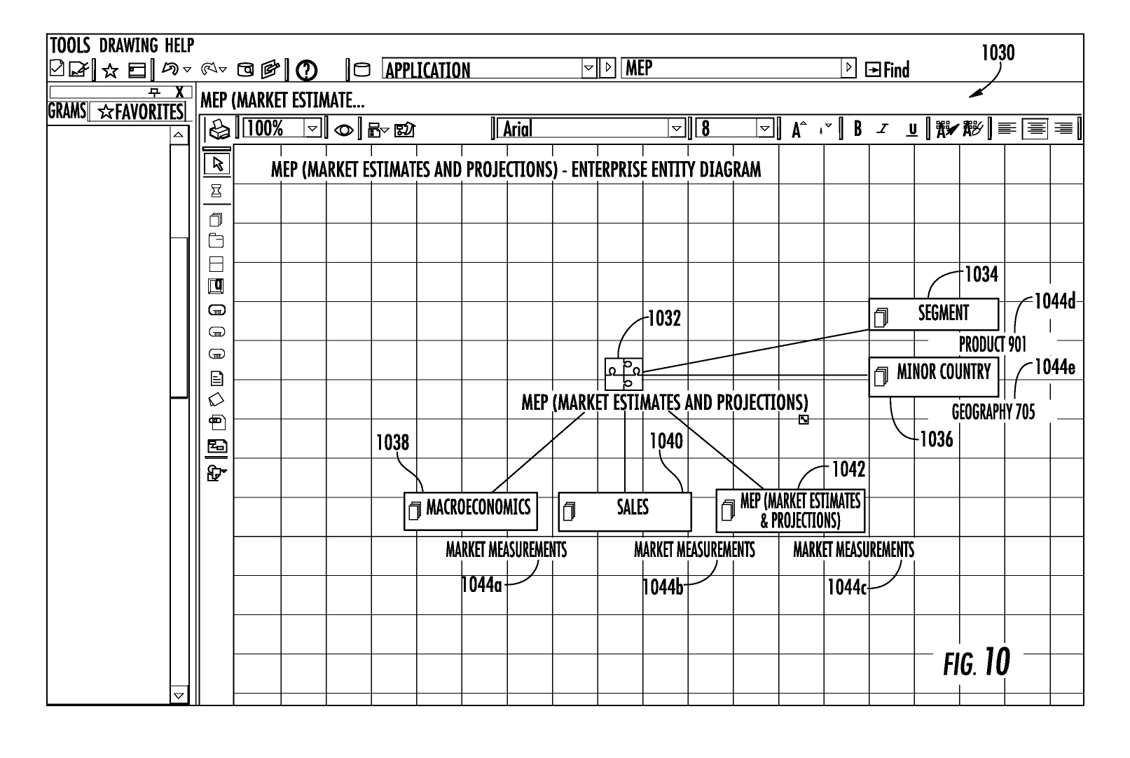

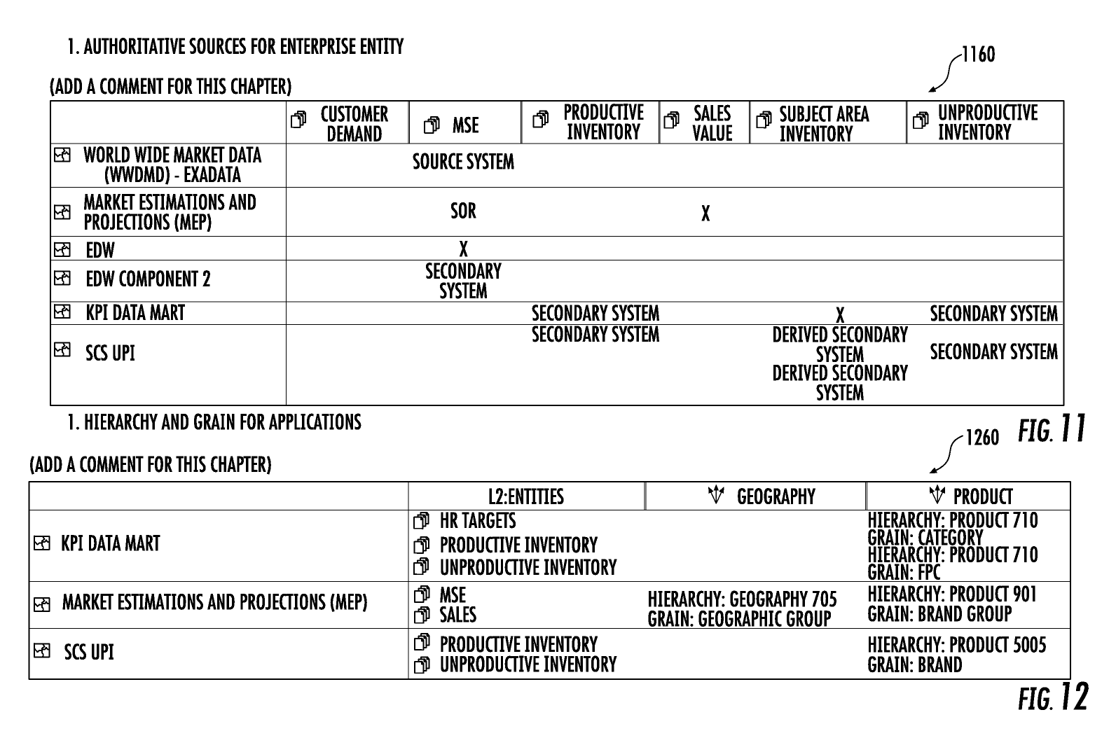

FIG. 11 depicts a table 1160 associated with a report for an enterprise entity, according to embodiments disclosed herein. Depending on the particular embodiment, the table 960 may be provided as part of a user interface, and/or may otherwise be provided. As illustrated, the table 960 provides authoritative sources for the example list of enterprise entity instances. This includes a listing of a plurality of applications, such as those that are provided in FIG. 4. Also included are the enterprise entity instances in a form of a customer demand column, an MSE column, a productive inventory column, a sales value column, a subject area inventory column, and an unproductive inventory column.

As illustrated, the table 1160 provides a report regarding which enterprise entities are associated with which applications, and to what extent. As an example, MSE is a source system for WWMD, but is a system of record (SOR) for the market estimations and projections (MEP) application. MSE data resides in the enterprise data warehouse (EDW) application, but EDW Component 2 serves as a secondary system for it. Accordingly, a user may be able to determine the interconnectivity of applications with enterprise entities.

FIG. 12 depicts a table 1260 for providing a report of hierarchy and grain data for applications, according to embodiments disclosed herein. As illustrated, the table 1260 provides enterprise entity hierarchy and hierarchy grain for a list of applications. As with the table 1160 from FIG. 11, the table 1260 may be provided as part of a user interface. Regardless, the table 1260 includes a listing of applications in a first column. As an example other columns include an entities column level 2 representing the one below the top level from the enterprise entity hierarchy, and at least one predetermined dimension associated with the said enterprise entities, in this example: a geography column, and a product column Accordingly, the table 1060 provides a listing of entities that are associated with applications with respect to characteristic type of enterprise entity associated with their dimensions and the lowest level (grain) of the characteristic available.

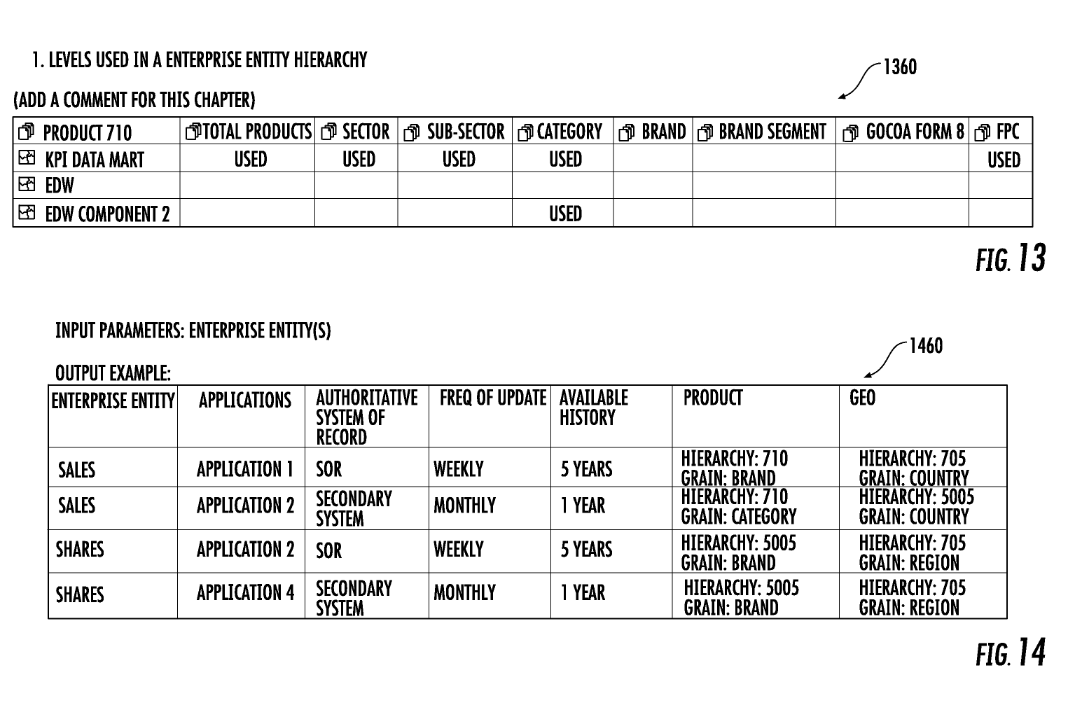

FIG. 13 depicts a table 1360 for providing a report of levels that are used in an enterprise entity hierarchy type characteristics which may be associated with regular enterprise entities, according to embodiments disclosed herein. As illustrated, the table 1160 includes levels utilized in an enterprise entity hierarchy. Accordingly, a plurality of applications associated with a particular level of enterprise entity type characteristics hierarchy may be provided. As illustrated, included are columns for a total products entity, a sector entity, a sub-sector entity, a category entity, a brand entity, a brand segment entity, a gocoa form 8 entity, and an FPC entity. Accordingly, a user can determine the applications that exist for the list of levels of enterprise entity type characteristics which determines the granularity of data available in the enterprise at different levels of particular perspective of an analysis represented by enterprise entity type characteristics.

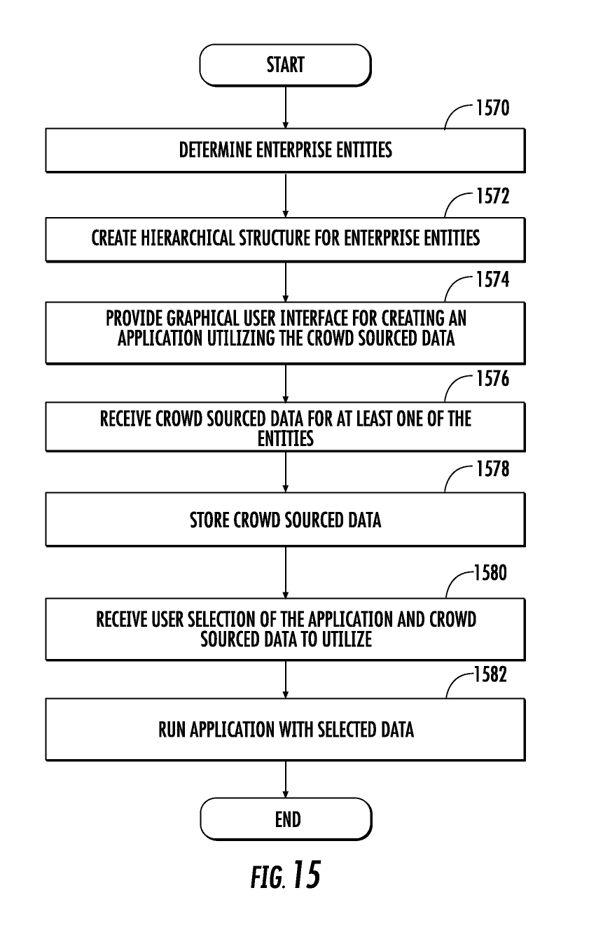

FIG. 14 depicts a table 1460 providing a report of output data for an enterprise entity application, according to embodiments disclosed herein. As illustrated, the table 1460 provides input and output parameters for a sample report. As an example, the sales and shares entities are the input parameters and as an output the report produces data related to the applications that utilize those enterprise entities (e.g. authoritative system of record, frequency of update available history). In some scenarios there may exist a relation between an application, regular enterprise entity and enterprise entity type characteristics with the latter associated with dimensions, in this case product, and geographical. From this information, a user may be able to view and optimize various aspects of an application and/or an enterprise entity.

FIG. 15 depicts a flowchart for providing hierarchical enterprise data management, according to embodiments disclosed herein. As illustrated in block 1570, enterprise entities may be determined In block 1572, a hierarchical structure for the enterprise entities may be created, which may include creating hierarchy of regular enterprise entities, creating a hierarchy (including a single level hierarchy) of enterprise entities type characteristics, and associating enterprise entity type characteristics into dimensions. In block 1574, a graphical user interface may be provided for associating an application with at least one of the enterprise entities (of any type). In block 1576, crowd sourced data for at least one of the entities may be received. In block 1578, the crowd sourced data may be stored. In block 1580, a user selection of the application and enterprise entity may be received for utilization. In block 1582, the application may be run with the crowd sourced data for enterprise entity. In block 1584, results of the application may be provided for display.

Every document cited herein, including any cross referenced or related patent or application is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be understood to those skilled in the art that various other changes and modifications can be made without departing from the spirit and scope of the invention. It is therefore intended to cover in the appended claims all such changes and modifications that are within the scope of this invention.

What is claimed is:

1. A system for hierarchical enterprise data management, comprising:
a processor; and
a memory component that stores logic, that when executed by the processor, causes the system to perform at least the following:
determine a plurality of enterprise entities for an enterprise;
create a hierarchical structure for the plurality of enterprise entities;
receive crowd sourced data for a selected enterprise entity of the plurality of enterprise entities;
provide a user interface for associating an application with the selected enterprise entity;
run the application with the crowd sourced data for the selected enterprise entity; and
provide results of the application for display.

2. The system of claim 1, wherein the selected enterprise entity is associated with a sub-entity in the hierarchical structure.

3. The system of claim 1, wherein the logic further causes the system to provide an option for a user to alter at least one of the following: the crowd sourced data, the selected enterprise entity, and the hierarchical structure.

4. The system of claim 1, wherein the logic further causes the system to provide a report associated with the application and the selected enterprise entity.

5. The system of claim 1, wherein the plurality of enterprise entities are determined prior to creation of the application.

6. The system of claim 1, wherein the plurality of enterprise entities are associated with dimensions.

7. The system of claim 1, wherein the logic further causes the system to provide a different user interface for creating a new application.

8. The system of claim 1, wherein the selected enterprise entity is configured for user in a plurality of different applications.

9. A method for hierarchical enterprise data management, comprising:
receiving, by a computing device, a plurality of enterprise entities for an enterprise;
creating, by the computing device, a hierarchical structure for the plurality of enterprise entities;
associating, by the computing device, type characteristics with a predetermined dimension;
associating, by the computing device, an application with a selected enterprise entity;
receiving, by the computing device, crowd sourced data for the selected enterprise entity;
running, by the computing device, the application with the crowd sourced data for the selected enterprise entity; and
providing, by the computing device, results of the application for display.

10. The method of claim 9, wherein the selected enterprise entity is associated with a sub-entity in the hierarchical structure.

11. The method of claim 9, further comprising providing option for a user to alter at least one of the following: the crowd sourced data, the selected enterprise entity, and the hierarchical structure.

12. The method of claim 9, further comprising providing a report associated with the application and the selected enterprise entity.

13. The method of claim 9, wherein the plurality of enterprise entities are determined prior to creation of the application.

14. The method of claim 9, wherein the logic further causes the computing device to provide a user interface for creating a new application.

15. The method of claim 9, wherein the selected enterprise entity is configured for user in a plurality of different applications.

16. A non-transitory computer-readable medium for hierarchical enterprise data management that stores logic that, when executed by a computing device, causes the computing device to perform the following:
determine a plurality of enterprise entities for an enterprise;
create a hierarchical structure for the plurality of enterprise entities;
associate enterprise entity type characteristics with a predetermined dimension;
provide a first user interface for associating an application with a selected enterprise entity;
receive crowd sourced data for the selected enterprise entity;
run the application with the crowd sourced data for the selected enterprise entity; and
provide results of the application for display.

17. The non-transitory computer-readable medium of claim 16, wherein the selected enterprise entity is associated with a sub-entity in the hierarchical structure.

18. The non-transitory computer-readable medium of claim 16, wherein the logic further causes the computing device to provide an option for a user to alter at least one of the following: the crowd sourced data, the selected enterprise entity, and the hierarchical structure.

19. The non-transitory computer-readable medium of claim 16, wherein the logic further causes the computing device to provide a report associated with the application and the selected enterprise entity.

20. The non-transitory computer-readable medium of claim 16, wherein the plurality of enterprise entities are determined prior to creation of the application.

21. The non-transitory computer-readable medium of claim 16, wherein the logic further causes the computing device to provide a second user interface for creating a new application.
